(19) United States
(12) Patent Application Publication
(10) Pub. No.: US 2014/0076232 A1
(43) Pub. Date: Mar. 20, 2014

(54) DEPOSITION APPARATUS

(71) Applicant: SAMSUNG DISPLAY CO., LTD., Yongin-City (KR)

(72) Inventors: Byoung Hee Park, Seoul (KR); Ok-Keun Song, Hwaseong-si (KR); Yonghan Lee, Seongnam-si (KR); Young Shin Lee, Seoul (KR)

(73) Assignee: SAMSUNG DISPLAY CO., LTD., Yongin-City (KR)

(21) Appl. No.: 13/785,063

(22) Filed: Mar. 5, 2013

(30) Foreign Application Priority Data
Sep. 17, 2012 (KR) 10-2012-0103011

(51) Int. Cl. B05C 21/00

(52) U.S. Cl. CPC B05C 21/00
USPC 118/712

(57) ABSTRACT

A deposition apparatus includes a plurality of deposition sources that provides different deposition materials to a substrate, a sensor assembly that senses a deposition thickness of the deposition materials evaporated from the deposition sources, and a main controller that controls the sensor assembly. The sensor assembly includes a plurality of sensor groups each including a plurality of sensors and respectively corresponding to the deposition sources, and each of the sensor groups senses the deposition thickness of the deposition material evaporated from a corresponding deposition source of the deposition sources to the substrate in response to a control of the main controller.

### CLAIM OF PRIORITY

This application makes reference to, incorporates the same herein, and claims all benefits accruing under 35 U.S.C. §119 from an application earlier filed in the Korean Intellectual Property Office on 17 Sep. 2012 and there duly assigned Serial No. 10-2012-0103011.

### BACKGROUND OF THE INVENTION

1. Field of the Invention

Embodiments of the present disclosure generally relate to a deposition apparatus, and more particularly, to a deposition apparatus capable of effectively utilizing sensors to measure a deposition thickness of a deposition material.

2. Description of the Related Art

In recent years, an organic light-emitting diode display apparatus has been spotlighted as a next generation display device since it has superior brightness and viewing angle and does not need to include a separate light source when compared to a liquid crystal display device. Accordingly, the organic light-emitting diode display apparatus has advantages of slimness and lightweight. In addition, the organic light-emitting diode display has attractive properties, e.g., fast response speed, low driving voltage, high brightness, etc.

In general, the organic light-emitting diode display apparatus includes an organic light emitting device configured to include an anode, an organic emitting layer, and a cathode. A hole and an electron are respectively injected into the organic emitting layer through the anode and the cathode, and are recombined in the organic emitting layer to generate an exciton. The exciton emits the energy discharged when an excited state returns to a ground state as light.

### SUMMARY OF THE INVENTION

Embodiments of the present invention provide a deposition apparatus capable of effectively utilizing sensors to measure a deposition thickness of a deposition material evaporated from deposition sources.

Embodiments of the present invention provide a deposition apparatus includes a plurality of deposition sources that provides different deposition materials to a substrate, a sensor assembly that senses a deposition thickness of the deposition materials evaporated from the deposition sources, and a main controller that controls the sensor assembly. The sensor assembly includes a plurality of sensor groups each including a plurality of sensors and respectively corresponding to the deposition sources, and each of the sensor groups senses the deposition thickness of the deposition material evaporated from a corresponding deposition source of the deposition sources to the substrate in response to a control of the main controller.

The deposition sources include a first deposition source that provides a first deposition material to the substrate and a second deposition source that provides a second deposition material different from the first deposition material to the substrate.

The sensor groups include a first sensor group that senses the deposition thickness of the first deposition material evaporated from the first deposition source to the substrate and a second sensor group that senses the deposition thickness of the second deposition material evaporated from the second deposition source to the substrate.

A ratio between a number of the sensors of the first sensor group and a number of the sensors of the second sensor group corresponds to a ratio between a use amount of the first deposition material and a use amount of the second deposition material.

The deposition apparatus further includes a sensor supporter part to support the sensor assembly, the sensor supporter part is disposed between the first deposition source and the second deposition source, and the sensor assembly is located at a relatively upper portion of the first and second deposition sources by the sensor supporter part.

The sensor assembly includes a housing, a rotation plate disposed in the housing, a sensing hole formed through a lower portion of the housing, and first and second sensor caps attached to the lower portion of the housing. Each of the first and second sensor caps includes openings formed through both ends thereof, the sensors of the first and second sensor groups are spaced apart from each other at regular intervals and arranged on a lower surface of the rotation plate in a circular shape, and the openings of upper ends of the first and second sensor caps are shared by the first and second sensor caps and overlapped with the sensing hole.

Each of the openings of lower ends of the first and second sensor caps are disposed to face an upper surface of a corresponding deposition source of the first and second deposition sources.

Each of the first and second sensor caps provides a path into which a corresponding deposition material of the first and second deposition materials evaporated from the first and second deposition sources is flowed.

The deposition apparatus further includes a deposition controller to operate one of the first deposition source and the second deposition source in response to a control of the main controller.

One sensor of the sensors of a corresponding sensor group of the first and second sensor groups, which corresponds to the operated deposition source of the first and second deposition sources by the deposition controller, is disposed to correspond to the sensing hole after the rotation plate is rotated by the control of the main controller.

When the one sensor is no longer of any use, another sensor of the corresponding sensor group is disposed to correspond to the sensing hole due to the rotation of the rotation plate rotated by the control of the main controller.

According to the above, the deposition apparatus may effectively measure the deposition thickness of the deposition material evaporated from the deposition sources using the sensors of the sensor assembly.

### BRIEF DESCRIPTION OF THE DRAWINGS

The above and other advantages of the present invention will become readily apparent by reference to the following detailed description when considered in conjunction with the accompanying drawings wherein:

FIG. 1 is a cross-sectional view showing a deposition apparatus constructed to the principle of the present invention as according to a first embodiment of the present invention;

FIG. 2 is a cross-sectional view showing a sensor assembly shown in FIG. 1;

FIG. 3 is an upper plan view showing a sensor assembly shown in FIG. 1;

FIGS. 4A and 4B are lower plan views showing a sensor assembly shown in FIG. 1;

FIG. 5 is a block diagram showing the deposition apparatus shown in FIG. 1;

FIG. 6 is a cross-sectional view showing a deposition apparatus constructed to the principle of the present invention as according to a second embodiment;

FIG. 7 is a cross-sectional view showing a deposition apparatus constructed to the principle of the present invention as according to a third embodiment; and

FIG. 8 is a cross-sectional view showing a deposition apparatus constructed to the principle of the present invention as according to a fourth embodiment.

### DETAILED DESCRIPTION OF THE INVENTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the present specification and the claims, use amount refers to the quantity of a deposition material consumed during a deposition process, evaporated amount refers to the quantity of a deposition material evaporated from a deposition source during a deposition process, and sublimated amount refers to the quantity of a deposition material deposited onto a substrate or a sensor.

A deposition apparatus used to manufacture an organic light-emitting diode display includes a deposition source that provides a deposition material to a substrate and a sensor assembly that measures a thickness of the deposition material provided on the substrate. The sensor assembly measures a deposition amount and a deposition speed of the deposition material evaporated from the deposition source. The thickness of the deposition material provided on the substrate is determined depending on the deposition amount and the deposition speed. When the deposition source is provided in a plural number and the deposition sources are filled with different deposition materials, the sensor assembly is provided in plural number to respectively correspond to the deposition sources. In this case, each sensor assembly measures the deposition amount and the deposition speed of the deposition material evaporated from a corresponding deposition source of the deposition sources.

Hereinafter, the present invention will be explained in detail with reference to the accompanying drawings.

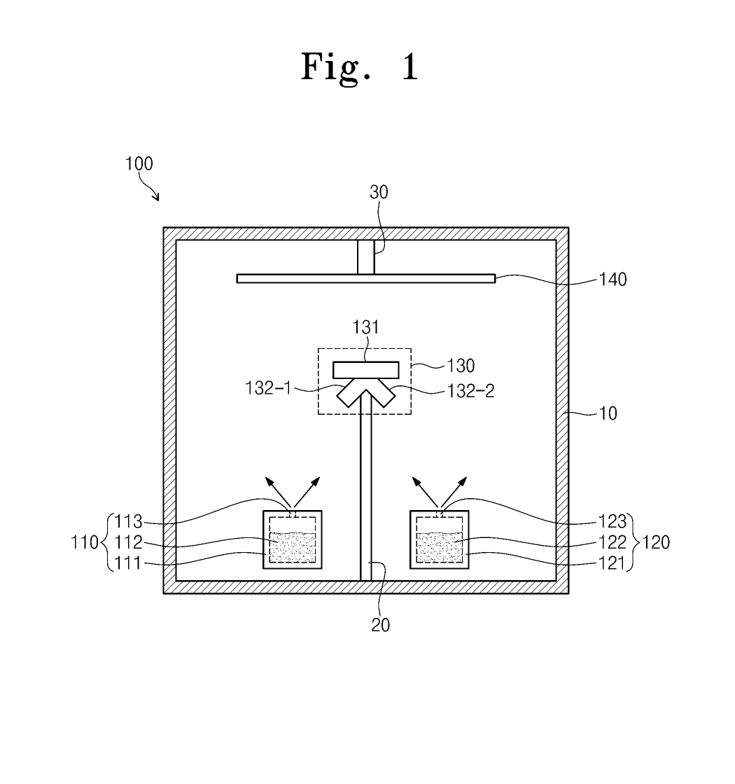

FIG. 1 is a cross-sectional view showing a deposition apparatus constructed according to the principles of the present invention as a first embodiment.

Referring to FIG. 1, a deposition apparatus 100 includes a vacuum chamber 10, a plurality of deposition sources 110 and 120, a sensor assembly 130, a substrate 140, a sensor supporter part 20, and a substrate supporter 30.

The vacuum chamber 10 prevents foreign substances from entering thereto and maintains a high vacuum state to secure a straightness property.

The deposition sources 110 and 120 are disposed at a lower portion in the vacuum chamber 10. The deposition sources 110 and 120 include a first deposition source 110 and a second deposition source 120. For the convenience of explanation, only two deposition sources 110 and 120 have been shown in FIG. 1, but the number of the deposition sources should not be understood as being limited to two.

The first deposition source 110 includes a first crucible 111, a first deposition material 112 filled in the first crucible 111, and a first spray hole 113 through which the first deposition material 112 is evaporated after being evaporated. The second deposition source 120 includes a second crucible 121, a second deposition material 122 filled in the second crucible 121, and a second spray hole 123 through which the second deposition material 122 is evaporated after being evaporated.

The first and second deposition materials 111 and 122 may be different from each other. That is, the first and second deposition sources 110 and 120 may be filled with different deposition materials to provide different materials to the substrate 140. For instance, the first deposition source 110 may be filled with a host material and the second deposition source 120 may be filled with a dopant material.

The first deposition source 110 and the second deposition source 120 may be selectively operated. In detail, when the first deposition source 110 is operated to deposit the first deposition material 112 on the substrate 140, the second deposition source 120 is not operated. In this case, the first deposition material 112 in the first deposition source 110 is evaporated and sublimated onto the facing major surface of the substrate 140 through the first spray hole 113. On the contrary, when the second deposition source 120 is operated to deposit the second deposition material 122 on the substrate 140, the first deposition source 110 is not operated. In this case, the second deposition material 122 in the second deposition source 120 is evaporated and provided to the substrate 140 through the second spray hole 123. Accordingly, the host material in the first deposition source 110 and the dopant material in the second deposition source 120 are deposit on the substrate 140.

Although not shown in FIG. 1, each of the first and second deposition sources 110 and 120 may further include a heater unit to evaporate the first and second deposition materials 112 and 122, respectively.

The substrate 140 is disposed at an upper portion in the vacuum chamber 10 so as to face the first and second deposition sources 110 and 120. The substrate 140 is held at the upper portion in the vacuum chamber 10 by the substrate supporter 30.

The sensor assembly 130 is supported by the sensor supporter part 20 to be disposed at a position corresponding to between the first and second deposition sources 110 and 120. The sensor assembly 130 is disposed above the first and second deposition sources 110 and 120. The sensor assembly 130 includes a housing 131 and a plurality of sensor caps 132-1 and 132-2 attached to a lower portion of the housing 131.

The sensor caps 132-1 and 132-2 have a cylindrical shape in which both ends thereof are open. The sensor caps 132-1 and 132-2 provide inflows through which the first and second deposition materials 112 and 122 evaporated from the first and second deposition sources 110 and 120 pass, respectively. Openings of upper ends of the sensor caps 132-1 and 132-2, which are attached to the lower portion of the housing 131, are shared by the sensor caps 132-1 and 132-2.

The sensor caps 132-1 and 132-2 include a first sensor cap 132-1 and a second sensor cap 132-2. Each of the first and second sensor caps 132-1 and 132-2 is disposed to face a corresponding deposition source of the first and second deposition sources 110 and 120. In detail, each of the openings of the lower ends of the first and second sensor caps 132-1 and 132-2 face the upper portion of the corresponding deposition source of the first and second deposition sources 110 and 120.

The first sensor cap 132-1 is disposed to face the first deposition material 112 evaporated from the first deposition source 110. The first deposition material 112 evaporated from the first deposition source 110 is evaporated onto the substrate 140 after inflowing into the opening of the lower portion of the first sensor cap 132-1 and passing through the first sensor cap 132-1.

The second sensor cap 132-2 is disposed to face the second deposition material 122 evaporated from the second deposition source 120. The second deposition material 122 evaporated from the second deposition source 120 is evaporated onto the substrate 140 after inflowing into the opening of the lower portion of the second sensor cap 132-2 and passing through the second sensor cap 132-2.

A plurality of sensors is disposed in the housing 131. In general, a crystal vibrator is used as the sensor. As an amount of material deposited on a surface of the crystal vibrator increases, the resonant frequency of the crystal vibrator decreases. Accordingly, a deposition amount and a deposition speed of the deposition material may be measured by variation in the frequency of the crystal vibrator. The sensors are responsive to the deposition material flowing into the first and second sensor caps 132-1 and 132-2. The sensors sense the deposition amounts and the deposition speeds of the deposition material flowing into the first and second sensor caps 132-1 and 132-2.

Although not shown in FIG. 1, sensor assembly 130 may include a first sensor group to sense the deposition amount and the deposition speed of the first deposition material 112 of the first deposition source 110 and a second sensor group to sense the deposition amount and the deposition speed of the second deposition material 122 of the second deposition source 120. The number of the sensors included in the first sensor group may be different from that of the sensors included in the second sensor group.

In the case that the first deposition material 112 from first deposition source 110 and sublimated onto substrate 140 by a deposition controller disposed outside vacuum chamber 10, the first sensor group is used, and in the case that the second deposition material 122 of the second deposition source 120 is provided onto the substrate 140 by the deposition controller, the second sensor group is used. The operation of the sensors will be described in detail later among the following paragraphs.

The number of sensors in the first sensor group and the number of the sensors in the second sensor group depend on the amount of the deposition material. In detail, a ratio between the number of sensors in the first sensor group and the number of sensors in the second sensor group corresponds to a ratio between the amount of the first deposition material used and the amount of the second deposition material used. For instance, the amount of the host material inserted into the first deposition source 110 is greater than the amount of the dopant material inserted into the second deposition source 120. In this case, the number of sensors in the first sensor group used for the first deposition source 110 is greater than the number of the sensors in the second sensor group used for the second deposition source 120.

The deposition apparatus 100 may measure the thickness of the deposition materials evaporated from two deposition sources 110 and 120 by using one sensor assembly 130.

For the convenience of explanation, one sensor assembly 130 and two deposition sources 110 and 120 have been shown in FIG. 1, but the number of the sensor assembly 130 and the number of the deposition sources 110 and 120 should not be limited to two. For example, the deposition apparatus 100 includes plural sensor assemblies and plural deposition sources and each sensor assembly measures the deposition thickness of the deposition materials evaporated from corresponding two deposition sources from among the deposition sources. In addition, each sensor assembly may measure the deposition thickness of the deposition materials evaporated from two or more deposition sources. In this case, the number of the sensor caps is determined to correspond to the number of the deposition sources, and the sensor assembly includes sensor groups corresponding to the deposition sources. The number of sensors in each group is determined by the ratio between the amounts of the deposition materials used.

Consequently, deposition apparatus 100 constructed according to the first embodiment may effectively measure the deposition thickness of the deposition material evaporated from the deposition sources 110 and 120 by using the sensors of the sensor assembly 130.

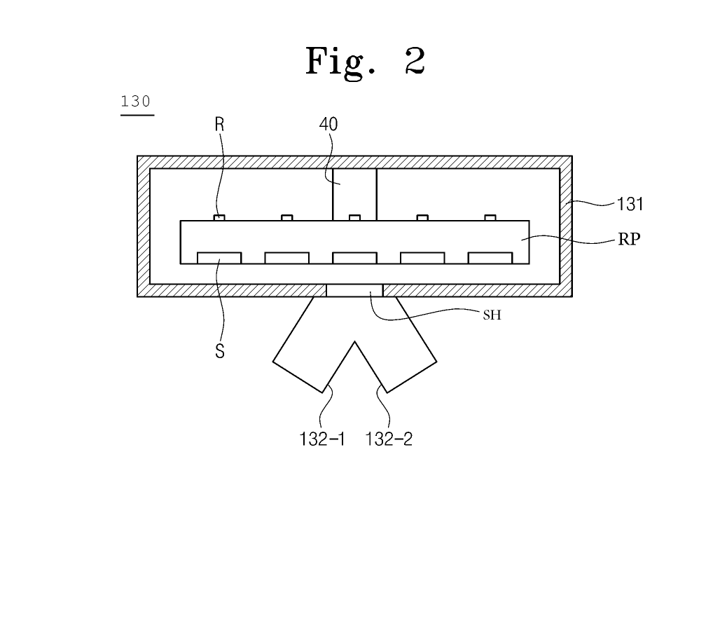

FIG. 2 is a cross-sectional view showing a sensor assembly 130 shown in FIG. 1.

Referring to FIG. 2, the sensor assembly 130 includes the housing 131, a rotation plate RP, a rotation axis 40, the sensors S, resistors R, the first and second sensor caps 132-1 and 132-2, and a sensing hole SH formed through the lower portion of the housing 131.

Each of the housing 131 and the rotation plate RP has a cylindrical shape. Individual ones of resistors R correspond to sensors S, respectively.

The rotation plate RP is disposed in the housing 131. The sensors S are disposed on the lower surface of the rotation plate RP. The resistors R are disposed on the upper surface of the rotation plate RP. The rotation axis 40 is disposed on the rotation plate RP and connected to the rotation plate RP to rotate the rotation plate RP.

The first and second sensor caps 132-1 and 132-2 are attached to the lower portion of the housing 131. The openings of the upper ends of the first and second sensor caps 132-1 and 132-2 attached to the housing 131 are shared with each other and overlapped with the sensing hole SH. The sensing hole SH is overlapped with one of the sensors S. The deposition material flowed through the openings of the lower ends of the first and second sensor caps 132-1 and 132-2 is provided to the sensor S, which is overlapped with the sensing hole SH, through the sensing hole SH.

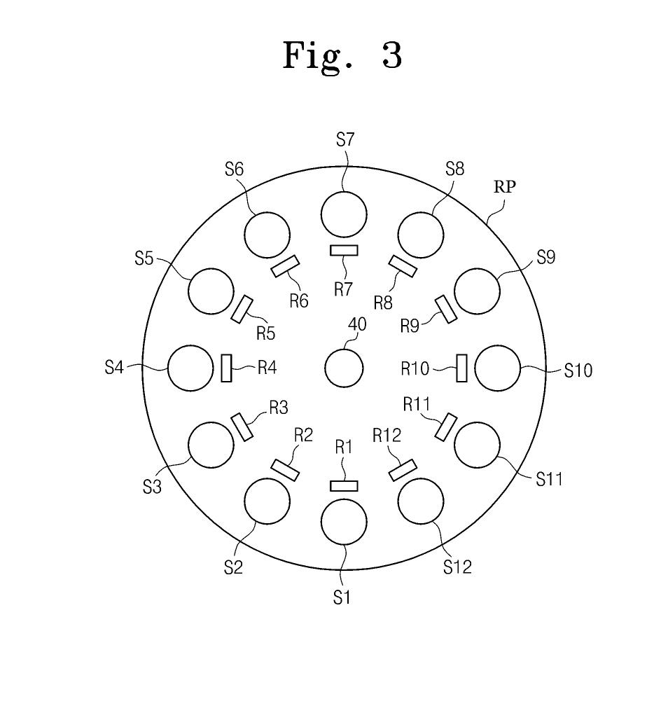

FIG. 3 is an upper plan view showing a sensor assembly shown in FIG. 1. For the convenience of explanation, housing 131 is omitted in FIG. 3.

Referring to FIG. 3, the sensors S include first through twelfth sensors S1 through S12 and the resistors R include first through twelfth resistors R1 through R12. The first through twelfth sensors S1 through S12 are spaced apart from each other at regular intervals and arranged in a circular shape on the lower surface of the rotation plate RP. The first through twelfth sensors R1 through R12 are spaced apart from each other at regular intervals and arranged in a circular shape on the upper surface of the rotation plate RP.

Each of the first through twelfth resistors R1 through R12 is disposed adjacent to a corresponding sensor of the first through twelfth sensors S1 through S12. In detail, the circular shape along which the first through twelfth sensors S1 through S12 are arranged is larger than the circular shape along which the first through twelfth resistors R1 through R12 are arranged. The first through twelfth resistors R1 through R12 are disposed closer to a center portion of the rotation plate RP than the first through twelfth sensors S1 through S12 on the upper surface of the rotation plate RP to be adjacent to the first through twelfth sensors S1 through S12, respectively.

The first through twelfth resistors R1 through R12 may have different resistances from each other. Inherent numbers of the first through twelfth sensors S1 through S12 are determined by the resistances of the first through twelfth resistors R1 through R12. For instance, although not shown in FIG. 3, the first through twelfth resistors R1 through R12 are connected to a main controller, which is disposed outside the vacuum chamber 10, through an electrical connector. Due to the above-mentioned configuration, the resistances of the first through twelfth resistors R1 through R12 are provided to the main controller. The main controller recognizes the inherent numbers of the first through twelfth sensors S1 through S12 respectively corresponding to the first to twelfth resistors R1 through R12 on the basis of the resistances of the first to twelfth resistors R1 through R12.

For convenience of explanation, twelve resistors R1 through R12 and twelve sensors S1 through S12 have been shown in FIG. 3, but the number of the resistors and the number of the sensors should not be limited to twelve.

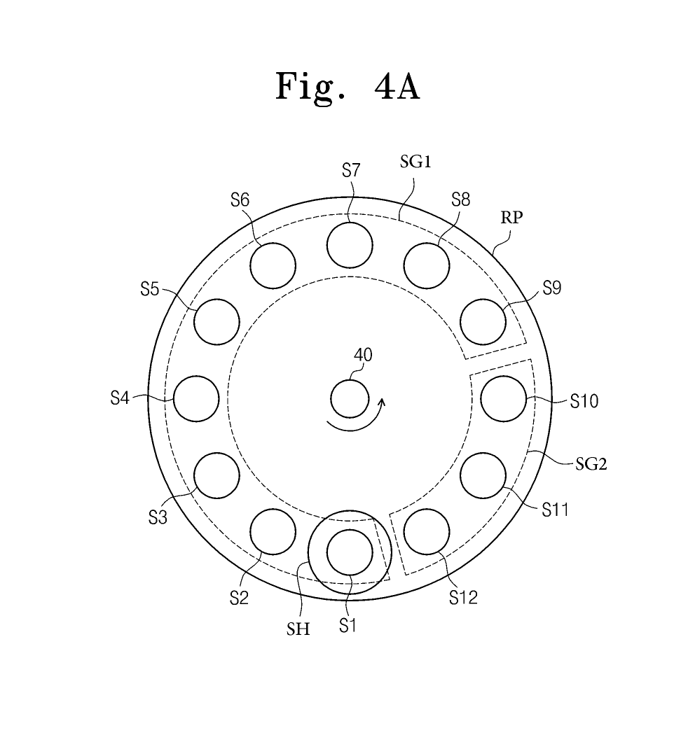

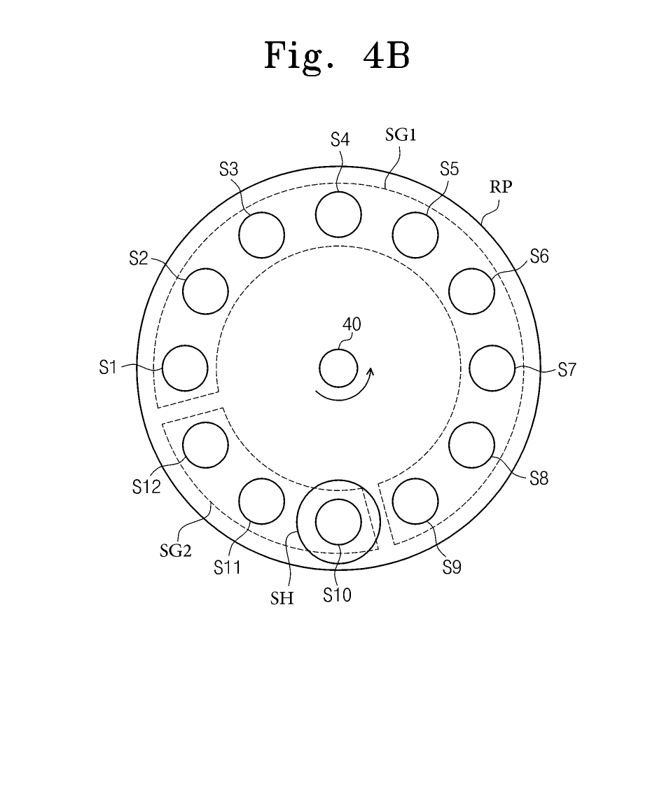

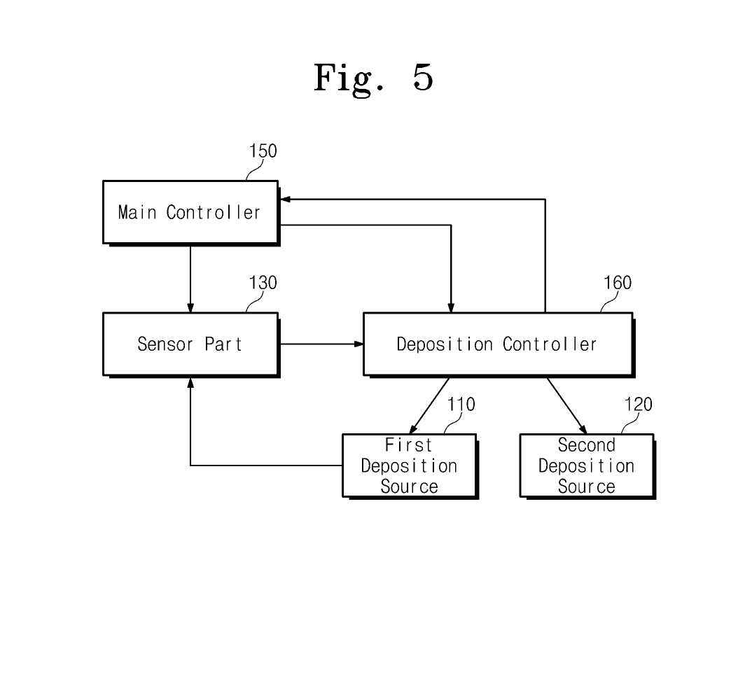

FIGS. 4A and 4B are lower plan views showing a sensor assembly shown in FIG. 1 and FIG. 5 is a block diagram showing the deposition apparatus shown in FIG. 1.

Referring to FIGS. 4A, 4B, and 5, the deposition apparatus 100 includes the main controller 150, the deposition controller 160, the sensor assembly 130, and first and second deposition sources 110 and 120.

The main controller 150 applies a control signal to the deposition controller 160 to operate the deposition sources. The control signal includes deposition source selection information and parameter values, e.g., a heating temperature of the selected deposition source, an evaporation rate of the deposition material, etc. For instance, in the case that the first deposition material 112 is deposited on the substrate 140, the main controller 150 applies the information to select the first deposition source 110 and the parameter values including the heating temperature to heat the first deposition source 110 and the evaporation rate of the first deposition material 112 to the deposition controller 160. In addition, in the case that the second deposition material 122 is deposited on the substrate 140, the main controller 150 applies the information to select the second deposition source 120 and the parameter values including the heating temperature to heat the second deposition source 120 and the evaporation rate of the second deposition material 122 to the deposition controller 160.

The deposition controller 160 operates one of the first deposition source 110 and the second deposition source 120 in response to the control signal provided from the main controller 150. For instance, the deposition controller 160 heats the first deposition source 110 at a predetermined temperature in response to the control signal provided from the main controller 150 so as to evaporate the first deposition material 112 at a predetermined rate.

The sensor assembly 130 is operated by the control of the main controller 150 and senses the deposition amount and the deposition speed of the deposition material evaporated from one of the first and second deposition sources 110 and 120. The sensed deposition amount and the sensed deposition speed are applied to the deposition controller 160. In detail, when the first deposition source 110 is operated by the deposition controller 160, the sensor assembly 130 senses the deposition amount and the deposition speed of the first deposition material 112 evaporated from the first deposition sources 110. The sensed deposition amount and the sensed deposition speed are applied to the deposition controller 160. The deposition controller 160 applies the sensed deposition amount and the sensed deposition speed of the first deposition material 112 to the main controller 150.

The main controller 150 measures the thickness of the deposition material deposited on the substrate 140 using the sensed deposition amount and the sensed deposition speed of the deposition material, which are provided from the deposition controller 160. When the thickness of the deposition material reaches a target thickness, the main controller 150 applies a control signal to the deposition controller 160 to stop the operation of the deposition source. The deposition controller 160 stops the operation of the deposition source in response to the control signal used to stop the operation of the deposition source. For instance, when the thickness of the first deposition material 112 deposited on the substrate 140 reaches the target thickness, the main controller 150 applies the control signal to the deposition controller 160 so as to stop the operation of the first deposition source 110. The deposition controller 160 stops the operation of the first deposition source 110 in response to the control signal used to stop the operation of the first deposition source 110.

The sensor assembly 130 includes the first sensor group SG1 and the second sensor group SG2. As an example, the first sensor group SG1 may be set to be operated when the first deposition material 112 is provided on the substrate 140 by the first deposition source 110. Similarly, the second sensor group SG2 may be set to be operated when the second deposition material 122 is provided on the substrate 140 by the second deposition source 120.

The ratio between the number of the sensors of the first sensor group SG1 and the number of the sensors in the second sensor group SG2 corresponds to the ratio between the amount of the first deposition material 112 used and the amount of the second deposition material 122. Thus, the number and the inherent number of the sensors of the first sensor group SG1 and the number and the inherent number of the sensors of the second sensor group SG2 may be set in accordance with the use amount of the deposition material used.

The first deposition material 112 and the second deposition material 122 may be the host material and the dopant material, respectively. In this case, the amount of the host material added to the first deposition source 110 is much more than the use amount of the dopant material added to the second deposition source 120. Accordingly, the number of the sensors of the first sensor group SG1 used for the first deposition source 110 is much more than the number of sensors in the second sensor group SG2 used for the second deposition source 120. For instance, when the ratio of the amount of the host material used and the amount of the dopant material used is 3:1, the ratio between the number of the sensors of the first sensor group SG1 and the number of the sensors of the second sensor group SG2 may be set to 3:1.

As shown in FIGS. 4A and 4B, the sensor assembly 130 includes the twelve sensors 51 through S12. Therefore, the number of the sensors of the first sensor group SG1 used for the first deposition source 110 is nine and the number of the sensors of the second sensor group SG2 used for the second deposition source 120 is three. The nine sensors of the first sensor group SG1 are respectively referred to as first through ninth sensors S1 through S9 and the three sensors of the second sensor group SG2 are respectively referred to as tenth through twelfth sensors S10 through S12.

The information is previously stored in the main controller 150. That is, the number of the sensors used to each deposition source and the inherent numbers of the sensors are previously stored in the main controller 150.

When the first deposition source 110 is operated by the deposition controller 160, the rotation plate RP is rotated by the control of the main controller 150 and one of the first through ninth sensors S1 through S9 of the first sensor group SG1 is disposed to correspond to the sensing hole SH. For example, in the case that the first deposition material 112 of the first deposition source 110 is provided on the substrate 140, the first sensor S1 of the first through ninth sensors S1 through S9 is disposed to correspond to the sensing hole SH by the control of the main controller 150.

As described above, the main controller 150 recognizes the inherent numbers of the first through twelfth sensors S1 through S12 on the basis of the resistances of the first through twelfth resistors R1 through R12 respectively corresponding to the first through twelfth sensors S1 through S12. Thus, the main controller 150 rotates the rotation plate RP in a counter-clockwise direction to allow the first sensor S1 to be disposed at the position corresponding to the sensing hole SH as shown in FIG. 4A.

The first deposition material 112 evaporated from the first deposition source 110 is provided on the substrate 140 and flowed into the first sensor cap 132-1. The first deposition material 112 flowed into the first sensor cap 132-1 is provided to the first sensor S1 through the sensing hole SH. The first sensor S1 senses the deposition amount and the deposition speed of the first deposition material 112 from the flowed first deposition material 112.

As the above-mentioned, since the crystal vibrator is used as the sensor, the resonant frequency of the crystal vibrator is decreased as the amount of the deposition material deposited on the surface of the crystal vibrator is increased. When the thickness of the deposition material deposited on the surface of the crystal vibrator becomes larger than a predetermined thickness, the crystal vibrator may not be used anymore. That is, when the frequency of the sensor becomes lower than a predetermined frequency due to the increase of the amount of the deposition material, the sensor is replaced with another sensor by the main controller 150.

In detail, the frequency of the first sensor S1 is applied to the deposition controller 160 and the deposition controller 160 applies the frequency of the first sensor S1 to the main controller 150. The main controller 160 stores a reference frequency value therein. The main controller 160 compares the frequency of the first sensor S1 with the reference frequency value. The main controller 160 rotates the rotation plate RP to allow the second sensor S2 to be disposed at the position corresponding to the sensing hole SH when the frequency of the first sensor S1 is smaller than the reference frequency value. That is, the main controller 160 rotates the rotation plate RP to allow the second sensor S2 to be disposed at the position corresponding to the sensing hole SH when the first sensor S1 is no longer of any use.

The deposition thickness of the first deposition material 112 evaporated from the first deposition source 110 is measured again by the second sensor S2 disposed to correspond to the sensing hole SH. As described above, the first to ninth sensors S1 to S9 may be used to measure the deposition thickness of the first deposition material 112.

When the second deposition source 120 is operated by the deposition controller 160, the rotation plate RP is rotated by the control of the main controller 150 and one of the tenth through twelfth sensors S10 through S12 of the second sensor group SG2 is disposed to correspond to the sensing hole SH. For instance, in the case that the second deposition material 122 of the second deposition source 120 is provided on the substrate 140, the tenth sensor S10 of the tenth through twelfth sensors S10 through S12 is disposed to correspond to the sensing hole SH by the control of the main controller 150. As shown in FIG. 4B, the main controller 150 rotates the rotation plate RP to allow the tenth sensor S10 to be disposed to at the position corresponding to the sensing hole SH.

The second deposition material 122 evaporated from the second deposition source 120 is provided on the substrate 140 and deposited on to the first sensor cap 132-2. The second deposition material 122 deposited onto the second sensor cap 132-2 is provided to the tenth sensor S10 through the sensing hole SH. The tenth sensor S10 senses the deposition amount and the deposition speed of the second deposition material 122 from the deposited quantity of second deposition material 122.

When the tenth sensor S10 is no longer of any use, the main controller 150 rotates the rotation plate RP so that the eleventh sensor S11 is disposed to correspond to the sensing hole SH. The deposition thickness of the second deposition material 122 evaporated from the second deposition source 120 is measured again by the eleventh sensor S11 disposed in correspondence to the sensing hole SH. As described above, the tenth through twelfth sensors S10 through S12 may be used to measure the deposition thickness of the second deposition material 122.

The deposition apparatus 100 measures the deposition thickness of the deposition materials evaporated from two deposition sources 110 and 120 using one sensor assembly 130. For the convenience of explanation, twelve sensors S1 through S12 have been shown in FIGS. 4A and 4B, but the number of the sensors should not be limited thereto or thereby. That is, twelve or more or fewer sensors may be used to measure the deposition thickness of the deposition materials and the number of the sensors of the first and second sensor groups SG1 and SG2 may be changed in accordance with the amount of the deposition materials.

Consequently, the deposition apparatus 100 constructed as the first embodiment may effectively measure the deposition thickness of the deposition materials evaporated from the deposition sources 110 and 120 by using the sensors of the sensor assembly 130.

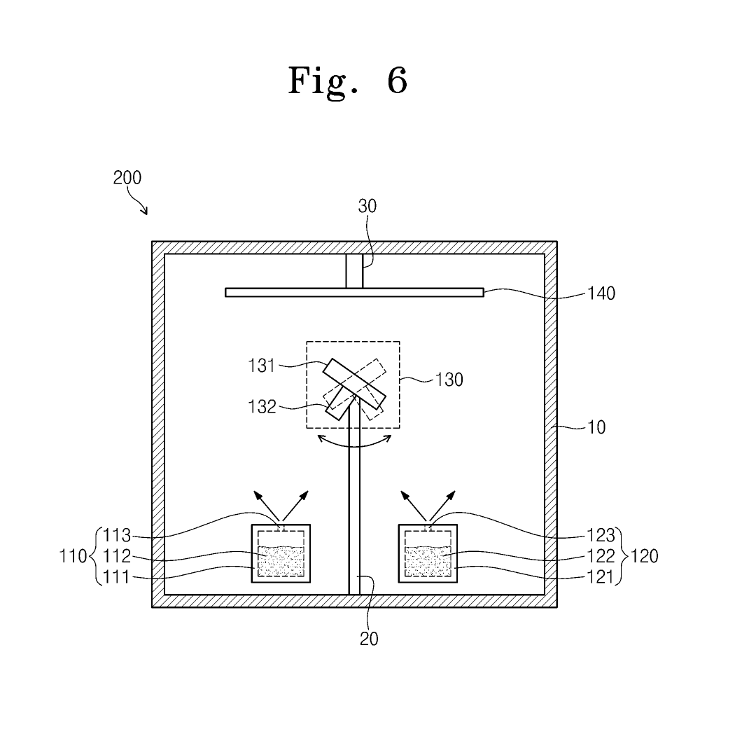

FIG. 6 is a cross-sectional view showing a deposition apparatus constructed as a second embodiment of the present invention.

The constituent components of deposition apparatus 200 constructed as the second embodiment have the same configuration and function as those of the deposition apparatus 100 for the first embodiment except for the configuration of the sensor assembly 130. Accordingly, hereinafter, the only different configurations from those of the deposition apparatus 100 will be described in detail.

Referring to FIG. 6, the sensor assembly 130 includes a housing 131 and a sensor cap 132 attached to the lower portion of the housing 131. The opening of the upper end of the sensor cap 132 attached to the lower portion of the housing 131 overlaps the sensing hole SH (not shown in FIG. 6).

The sensor cap 132 of the sensor assembly 130 is movable to face one of the deposition sources 110 and 120, from which the deposition material is evaporated. For instance, the opening of the lower end of the sensor cap 132 of the sensor assembly 130 is movable in the left and right directions along a circular arc. In the case that the first deposition material 112 of the first deposition source 110 is provided onto the substrate 140, the sensor assembly 130 moves by the control of the main controller 150 to allow the opening of the lower end of the sensor cap 132 to face the first deposition material 112 evaporated from the first deposition source 110. In the case that the second deposition material 122 of the second deposition source 120 is provided onto the substrate 140, the sensor assembly 130 moves under the control of the main controller 150 to allow the opening of the lower end of the sensor cap 132 to face the second deposition material 122 evaporated from the second deposition source 120.

Although not shown in FIG. 6, a motor driven assembly may be provided above the sensor supporter part 20 so as to rotate the sensor assembly 130.

The other constituent components used in the configuration of the sensor assembly 130 are the same as that of the sensor assembly 130 of the disposition apparatus 100 according to the first embodiment. That is, when the first deposition material 112 of the first deposition source 110 is evaporated onto the substrate 140, the first through ninth sensors S1 through S9 may be used, and when the second deposition material 122 of the second deposition source 120 is evaporated onto the substrate 140, the tenth through twelfth sensors S10 through S12 may be used.

Consequently, the deposition apparatus 200 constructed according to the second embodiment may effectively measure the deposition thickness of the deposition materials evaporated from the deposition sources 110 and 120 by using the sensors of the sensor assembly 130.

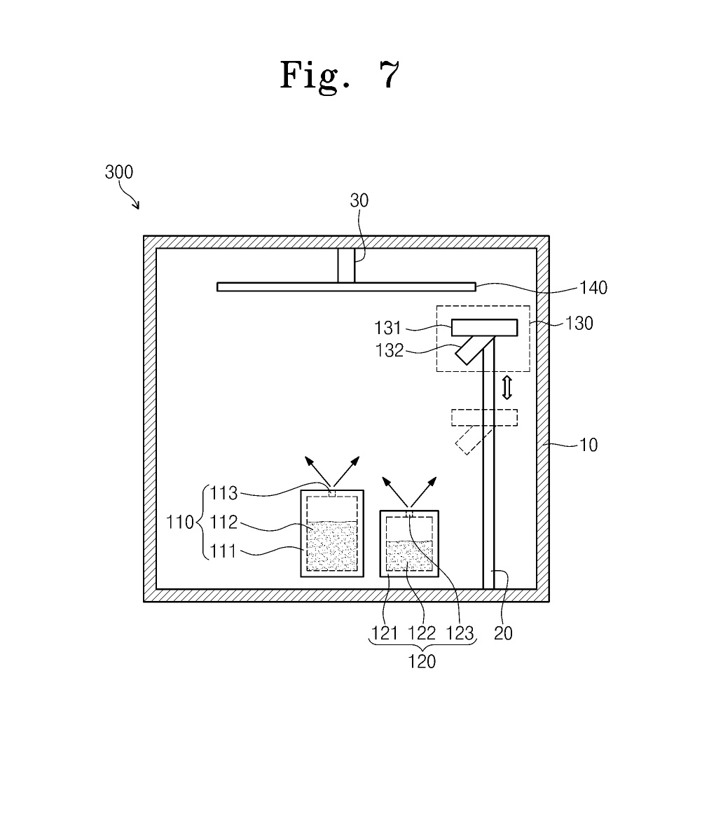

FIG. 7 is a cross-sectional view showing a deposition apparatus constructed as a third embodiment of the present invention.

The deposition apparatus 300 constructed as the third embodiment may have the same configuration and function as those of the deposition apparatus 100 according to the first embodiment except for the configuration of the sensor assembly 130. Accordingly, hereinafter, only those configurations that differ from those of the deposition apparatus 100 will be described in detail.

Referring now to FIG. 7, the sensor assembly 130 includes a housing 131 and a sensor cap 132 attached to the lower portion of the housing 131. The opening of the upper end of the sensor cap 132 attached to the lower portion of the housing 131 overlaps the sensing hole SH (not shown in FIG. 7).

The first and second deposition sources 110 and 120 have different sizes from each other. The first deposition source 110 is filled with the host material to be used as the first deposition material 112 and the second deposition source 120 is filled with the dopant material to be used as the second deposition material 122. In this case, the first deposition source 110 is filled with the host material, which is used in a much greater quantity than the dopant material, has the size larger than that of the second deposition source 120 as shown in FIG. 7. In detail, the first deposition source 110 has a height from the lower surface thereof to the upper surface thereof that is greater than a height of the second deposition source 120, which is from the lower surface of the second deposition source 120 to the upper surface of the second deposition source 120.

The sensor assembly 130 is located at either a left or right side of the first and second deposition sources 110 and 120 to be adjacent to the first and second deposition sources 110 and 120. For instance, the sensor assembly 130 is located at the right side of the first and second deposition sources 110 and 120 to be spaced apart from and adjacent to the first and second deposition sources 110 and 120 as shown in FIG. 7.

The sensor cap 132 may be configured to face the upper surface of the first and second deposition sources 110 and 120. The sensor cap 132 of the sensor assembly 130 is movable to face one of the first and second deposition sources 110 and 120, from which the deposition material is evaporated. In detail, the sensor assembly 130 may move between upper and lower directions along the sensor supporter part 20. When the first deposition material 112 of the first deposition source 110 is evaporated onto the substrate 140, the sensor assembly 130 moves in the upper direction in response to the control of the main controller 150 such that the opening of the lower end of the sensor cap 132 faces the first deposition material 112 evaporated from the first deposition source 110. When the second deposition material 122 of the second deposition source 120 is evaporated onto the substrate 140, the sensor assembly 130 moves in the lower direction in response to the control of the main controller 150 so that the opening of the lower end of the sensor cap 132 faces the second deposition material 122 evaporated from the second deposition source 120.

The other configuration of the sensor assembly 130 is the same as that of the sensor assembly 130 of the disposition apparatus 100 according to the first embodiment. That is, when the first deposition material 112 of the first deposition source 110 is evaporated onto the substrate 140, the first through ninth sensors S1 through S9 may be used, and when the second deposition material 122 of the second deposition source 120 is evaporated onto the substrate 140, the tenth through twelfth sensors S10 through S12 may be used.

Consequently, the deposition apparatus 300 constructed as the third embodiment may effectively measure the deposition thickness of the deposition materials evaporated from the deposition sources 110 and 120 by using the sensors of the sensor assembly 130.

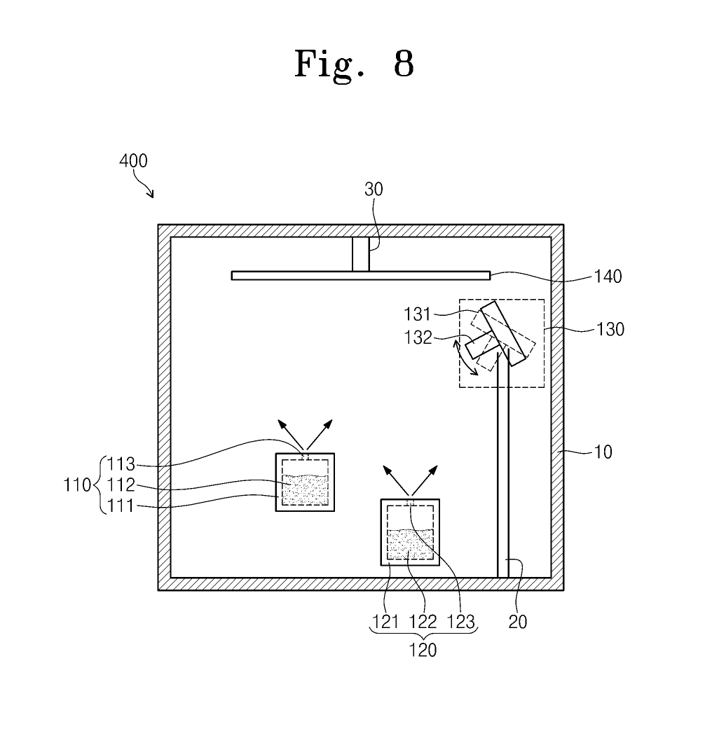

FIG. 8 is a cross-sectional view showing a deposition apparatus constructed as a fourth embodiment of the present invention.

The constituent components for deposition apparatus 400 constructed as the fourth exemplary embodiment have the same configuration and function as those of the deposition apparatus 100 according to the first exemplary embodiment except for the configuration of the sensor assembly 130. Accordingly, hereinafter, the only configurations that differ from those for the deposition apparatus 100 will be described in detail.

Referring to FIG. 8, the sensor assembly 130 includes a housing 131 and a sensor cap 132 attached to the lower portion of the housing 131. The opening of the upper end of the sensor cap 132 attached to the lower portion of the housing 131 is overlapped with the sensing hole SH (not shown in FIG. 8).

The first and second deposition sources 110 and 120 may be disposed at different heights relative to the ground and relative to each other. The sensor assembly 130 is located at a left or right side of the first and second deposition sources 110 and 120 to be adjacent to the first and second deposition sources 110 and 120. For instance, the sensor assembly 130 is located at the right side of the first and second deposition sources 110 and 120 to be spaced apart from and adjacent to the first and second deposition sources 110 and 120 as shown in FIG. 8.

The sensor cap 132 of the sensor assembly 130 is movable to face one of the first and second deposition sources 110 and 120, from which the deposition material is evaporated. For instance, the sensor assembly 130 is rotated in left and right directions along the circular arc to allow the opening of the lower end of the sensor cap 132 to face one of the first deposition material 112 evaporated from the first deposition source 110 and the second deposition material 122 evaporated from the second deposition source 120. When the first deposition material 112 of the first deposition source 110 is evaporated onto the substrate 140, the sensor assembly 130 is rotated in response to the control of the main controller 150 to allow the opening of the lower end of the sensor cap 132 to face the first deposition material 112 evaporated from the first deposition source 110. When the second deposition material 122 of the second deposition source 120 is evaporated onto the substrate 140, the sensor assembly 130 is rotated in response to the control of the main controller 150 to allow the opening of the lower end of the sensor cap 132 to face the second deposition material 122 evaporated from the second deposition source 120.

The other configuration of the sensor assembly 130 is the same as that of the sensor assembly 130 of the disposition apparatus 100 for the first embodiment. That is, when the first deposition material 112 of the first deposition source 110 is evaporated onto the substrate 140, the first through ninth sensors S1 through S9 may be used, and when the second deposition material 122 of the second deposition source 120 is evaporated onto the substrate 140, the tenth through twelfth sensors S10 through S12 may be used.

Consequently, the deposition apparatus 400 constructed as the fourth embodiment may effectively measure the deposition thickness of the deposition materials evaporated from the deposition sources 110 and 120 by using the sensors of the sensor assembly 130.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A deposition apparatus comprising:
a plurality of deposition sources that provide different deposition materials to a substrate;
a sensor assembly that senses a deposition thickness of the deposition materials evaporated from the deposition sources; and
a main controller that controls the sensor assembly,
the sensor assembly comprising a plurality of sensor groups, each of the sensor groups including a plurality of sensors respectively corresponding to the deposition sources, and each of the sensor groups sensing deposition thicknesses of the deposition materials evaporated from corresponding deposition sources onto the substrate under control of the main controller.

2. The deposition apparatus of claim 1, wherein the deposition sources comprise:
a first deposition source that provides a first deposition material to the substrate; and
a second deposition source that provides a second deposition material different from the first deposition material to the substrate.

3. The deposition apparatus of claim 2, wherein the sensor groups comprise:
a first sensor group that senses the deposition thickness of the first deposition material evaporated from the first deposition source onto the substrate; and
a second sensor group that senses the deposition thickness of the second deposition material evaporated from the second deposition source onto the substrate.

4. The deposition apparatus of claim 3, wherein a ratio between a number of the sensors of the first sensor group and a number of the sensors of the second sensor group corresponds to a ratio between an amount of the first deposition material evaporated and an amount of the second deposition material evaporated.

5. The deposition apparatus of claim 2, further comprising a sensor supporter 30 to support the sensor assembly, wherein the sensor supporter is disposed between the first deposition source and the second deposition source and the sensor assembly is located at a relatively upper portion of the first and second deposition sources by the sensor supporter.

6. The deposition apparatus of claim 2, wherein the sensor assembly comprises:
a housing:
a rotation plate disposed in the housing;
a sensing hole formed through a lower portion of the housing; and
first and second sensor caps attached to the lower portion of the housing, each of the first and second sensor caps including openings formed through both ends thereof, the sensors of the first and second sensor groups being spaced apart from each other at regular intervals and arranged on a lower surface of the rotation plate in a circular shape, and the openings of upper ends of the first and second sensor caps being shared by the first and second sensor caps and overlapping the sensing hole.

7. The deposition apparatus of claim 6, wherein each of the openings of lower ends of the first and second sensor caps are disposed to face an upper surface of a corresponding deposition source of the first and second deposition sources.

8. The deposition apparatus of claim 7, wherein each of the first and second sensor caps provides a path into which a corresponding deposition material of the first and second deposition materials evaporated from the first and second deposition sources is flowed.

9. The deposition apparatus of claim 7, further comprising a deposition controller to operate one of the first deposition source and the second deposition source under control of the main controller.

10. The deposition apparatus of claim 9, wherein one sensor of the sensors of a corresponding sensor group of the first and second sensor groups, which corresponds to the operated deposition source from among the first and second deposition sources by the deposition controller, is disposed to correspond to the sensing hole after the rotation plate is rotated by the control of the main controller.

11. The deposition apparatus of claim 10, wherein another sensor of the corresponding sensor group is disposed to correspond to the sensing hole due to the rotation of the rotation plate under control of the main controller when the one sensor is no longer of any use.

12. The deposition apparatus of claim 2, wherein the sensor assembly comprises:
a housing:
a rotation plate disposed in the housing;
a sensing hole formed through a lower portion of the housing; and
a sensor cap attached to the lower portion of the housing and including openings formed through both ends thereof, the sensors of the first and second sensor groups being spaced apart from each other at regular intervals and arranged on a lower surface of the rotation plate in a circular shape, and the opening of an upper end of the sensor cap overlapping the sensing hole.

13. The deposition apparatus of claim 12, further comprising a deposition controller operating one of the first and second deposition sources under control of the main controller, and one sensor of the sensors of a corresponding sensor group of the first and second sensor groups, which corresponds to the deposition source from among the first and second deposition sources activated by the deposition controller, is disposed to correspond to the sensing hole after the rotation plate is rotated under control of the main controller.

14. The deposition apparatus of claim 12, wherein the sensor cap of the sensor assembly moves to face a corresponding deposition material from among the first and second materials, which is evaporated from the corresponding deposition source of the first and second deposition sources.

15. The deposition apparatus of claim 14, wherein the sensor assembly is disposed between the first and second deposition sources to be located at a relatively upper portion of the first and second deposition sources, the opening of a lower end of the sensor cap moving in left and right directions along a circular arc in response to the control of the main controller, and the opening of the lower end of the sensor cap is disposed to face the corresponding deposition material of the first and second materials, which is evaporated from deposition sources from among the first and second deposition sources.

16. The deposition apparatus of claim 14, wherein the first and second deposition sources have different sizes from each other, the sensor cap is configured to face upper surfaces of the first and second deposition sources, and the sensor assembly is disposed at a left or right side of the first and second deposition sources to be spaced apart from and adjacent to the first and second deposition sources.

17. The deposition apparatus of claim 16, wherein the sensor assembly moves towards and away from the substrate in response to the control of the main controller and the opening of the lower end of the sensor cap is disposed to face the corresponding deposition material of the first and second materials, which is evaporated from the operated deposition source of the first and second deposition sources.

18. The deposition apparatus of claim 14, wherein the first and second deposition sources are located at different heights from each other and the sensor assembly is disposed at a left or right side of the first and second deposition sources to be spaced apart from and adjacent to the first and second deposition sources.

19. The deposition apparatus of claim 18, wherein the sensor assembly moves to allow the opening of a lower end of the sensor cap to move in left and right directions along a circular arc in response to the control of the main controller, and the opening of the lower end of the sensor cap is disposed to face the corresponding deposition material of the first and second materials, which is evaporated from the operated deposition source of the first and second deposition sources.
